(19) United States
(12) Patent Application Publication
(10) Pub. No.: US 2026/0121072 A1
(43) Pub. Date: Apr. 30, 2026

(54) NEGATIVE ELECTRODE CURRENT COLLECTOR FOR ZINC ION BATTERY, MANUFACTURING METHOD THEREOF AND ZINC ION BATTERY COMPRISING THE SAME

(71) Applicant: UIF (University Industry Foundation), Yonsei University, Seoul (KR)

(72) Inventors: Sang Young LEE, Seoul (KR); Dae Woo KIM, Seoul (KR); Won Yeong KIM, Seoul (KR); A Hyeon SON, Seoul (KR); Oh Chan KWON, Seoul (KR)

(73) Assignee: UIF (University Industry Foundation), Yonsei University, Seoul (KR)

(21) Appl. No.: 19/364,788

(22) Filed: Oct. 21, 2025

(30) Foreign Application Priority Data
Oct. 29, 2024 (KR) 10-2024-0149209
May 23, 2025 (KR) 10-2025-0067460

(51) Int. Cl. H01M 4/66; H01M 4/02; H01M 4/80; H01M 10/0563

(52) U.S. Cl. CPC H01M 4/667; H01M 4/663; H01M 4/80; H01M 10/0563; H01M 2004/021; H01M 2004/027; H01M 2300/002

(57) ABSTRACT

The present invention relates to a negative electrode current collector for a zinc-ion battery, a method for manufacturing the same, and a zinc-ion battery comprising the same. More specifically, the negative electrode current collector for a zinc-ion battery of the present invention can prevent side reactions such as hydrogen evolution reaction, corrosion, and dendritic growth of zinc by forming a carbon nanotube derivative-based protective film layer on the negative electrode current collector substrate, and can remarkably improve the electrochemical stability and interfacial stability between the electrode and the electrolyte. In addition, a thin and uniform protective film layer can be formed with a simple manufacturing process, and large-area application is possible. Furthermore, by applying the negative electrode current collector for a zinc-ion battery to a zinc-ion battery, there is an advantage of achieving excellent charge/discharge efficiency, long lifespan, and fast charging capability.

### CROSS-REFERENCE TO RELATED APPLICATION

This application claims priorities to Korean Patent Applications Nos. 10-2024-0149209 and 10-2025-0067460, filed on Oct. 29, 2024 and May 23, 2025, respectively, and all the benefits accruing therefrom under 35 U.S.C. § 119, the contents of which in its entirety are herein incorporated by reference.

### BACKGROUND

### 1. Field

The present invention relates to a negative electrode current collector for a zinc ion battery, a manufacturing method thereof, and a zinc ion battery comprising the same.

### 2. Description of the Related Art

As the era of carbon neutrality arrives, global environmental regulations are intensifying worldwide, and eco-friendly secondary battery businesses are gaining attention. Lithium-ion batteries, which currently lead the market, have problems such as high material and production costs, and safety issues due to ignition/explosion of flammable organic electrolytes. As a result, eco-friendly, low-cost zinc-ion batteries, which utilize abundant eco-friendly materials on Earth and possess high safety, are drawing attention.

However, zinc metal used as a negative electrode corrodes in water-based electrolytes, generates hydrogen gas, and during charging and discharging, zinc metal grows into sharp dendrites, and also forms a passivation film that ions cannot pass through, which leads to problems of decreased battery life and efficiency. As a solution to these problems, the fabrication of a protective film that limits direct contact between water and zinc metal is gaining attention.

Recently, various material-based protective films such as porous organic frameworks, polymers, and carbon-based materials have been proposed, but their practical application is limited due to complex synthesis and fabrication processes under high temperature and high pressure conditions, high cost, difficulty in fabricating thin and uniform protective films, and difficulty in large-area application.

### REFERENCES

Korean patent publication No. 10-2023-0129894

### SUMMARY

To solve the above problems, the present invention aims to provide a negative electrode current collector for a zinc-ion battery, wherein side reactions of an electrode are suppressed, and electrochemical stability and interfacial stability between the electrode and the electrolyte are remarkably improved.

Furthermore, the present invention aims to provide a zinc-ion battery comprising the negative electrode current collector of the present invention and a negative electrode.

Additionally, the present invention aims to provide a zinc-ion battery comprising the negative electrode current collector of the present invention.

Moreover, the present invention aims to provide a device comprising the zinc-ion battery of the present invention.

The present invention also aims to provide a method for manufacturing a negative electrode current collector for a zinc-ion battery.

The present invention provides a negative electrode current collector for a zinc ion battery, comprising: a negative electrode current collector substrate; and a protective film layer located on the negative electrode current collector substrate and including a three-dimensional porous scaffold structure containing a carbon nanotube derivative.

The negative electrode current collector for a zinc ion battery of the present invention can prevent side reactions such as hydrogen evolution reaction, corrosion, and dendritic growth of zinc by forming a carbon nanotube derivative-based protective film layer on the negative electrode current collector substrate, and can significantly improve the electrochemical stability and interfacial stability between the electrode and the electrolyte. Furthermore, a thin and uniform protective film layer can be formed with a simple manufacturing process, and large-area application is possible.

Furthermore, by applying the negative electrode current collector for a zinc-ion battery of the present invention to a zinc-ion battery, there is an advantage of achieving excellent charge/discharge efficiency, long lifespan, and fast charging capability.

The effects of the present invention are not limited to those mentioned above. The effects of the present invention should be understood to include all effects inferable from the description below.

### BRIEF DESCRIPTION OF THE DRAWINGS

FIG. 1 is a diagram comparing a conventional zinc battery negative electrode and a negative electrode utilizing a negative electrode current collector for a zinc-ion battery according to the present invention.

FIG. 2 is a schematic diagram schematically illustrating a method for manufacturing a negative electrode current collector for a zinc-ion battery according to the present invention.

FIG. 3 is a photograph showing solvent dispersibility evaluation results for MWNT (multi-walled carbon nanotube) and GONR (graphene oxide nanoribbon), which are starting materials of Example 1 according to the present invention, with respect to NMP, DMF, H₂O, IPA, EtOH, and Acetone solvents.

FIG. 4 shows SEM and EDS analysis results of the GONR-Cu negative electrode current collector manufactured in Example 1 according to the present invention.

FIG. 5 is a photograph of the GONR-Cu negative electrode current collector manufactured in Example 1 according to the present invention, produced using a slot die coater.

FIG. 6 is a Coulombic efficiency graph according to the number of cycles for the Zn∥GONR-Cu cell and Zn∥p-Cu cell, respectively, manufactured using the GONR-Cu negative electrode current collector of Example 1 and the p-Cu negative electrode current collector of Comparative Example 1 according to the present invention.

FIG. 7 is a graph showing the specific capacity and Coulombic efficiency over 3000 cycles for the Zn@GONR-Cu∥CVO cell of Example 3 and the Zn@p-Cu∥CVO cell of Comparative Example 3 according to the present invention.

FIG. 8 is a graph showing the specific capacity and Coulombic efficiency over 150 cycles for the GONR-Cu∥ZnₓCVO anode-free cell of Example 4 and the p-Cu∥ZnₓCVO anode-free cell of Comparative Example 4 according to the present invention.

### DETAILED DESCRIPTION

Hereinafter, the present invention will be described in more detail with one embodiment.

The present invention relates to a negative electrode current collector for a zinc-ion battery, a method for manufacturing the same, and a zinc-ion battery comprising the same.

As described above, in the past, various material-based protective films such as porous organic frameworks, polymers, and carbon-based materials have been proposed as protective films to limit direct contact between water and zinc metal, but their practical application has been limited due to complex synthesis and fabrication processes under high temperature and high pressure conditions, high cost, and difficulties in fabricating thin and uniform protective films and expanding the area.

Accordingly, in the present invention, by manufacturing a negative electrode current collector for a zinc-ion battery by forming a carbon nanotube derivative-based protective film layer on the negative electrode current collector substrate, side reactions such as hydrogen evolution reaction, corrosion, and dendritic growth of zinc can be prevented, and electrochemical stability and interfacial stability between the electrode and the electrolyte can be remarkably improved.

There is an advantage of achieving excellent charge/discharge efficiency, long lifespan, and fast charging capability by applying it to a zinc-ion battery.

Specifically, the present invention provides a negative electrode current collector for a zinc-ion battery, comprising: a negative electrode current collector substrate; and a protective film layer located on the negative electrode current collector substrate and comprising a three-dimensional porous scaffold structure containing a carbon nanotube derivative.

The negative electrode current collector may be at least one selected from the group consisting of a copper foil, a graphite foil, a carbon fiber, a zinc foil, titanium, and stainless steel, preferably a copper foil or a zinc foil, and most preferably a copper foil.

The protective film layer may be a three-dimensional porous scaffold structure containing the carbon nanotube derivative. Here, the three-dimensional porous scaffold structure may be one in which the carbon nanotube derivative forms a sponge-like porous structure intertwined by self-assembly, and the pore size of the scaffold may be at a level of 1 to 500 nm in diameter.

The carbon nanotube derivative may be formed by dispersing carbon nanotubes in an acid solvent and then reacting with an oxidant. Since carbon nanotubes are rich in nonpolar carbon and exhibit very low dispersibility in a solvent during the preparation of a coating solution, it may be difficult to form a uniform protective film layer on the negative electrode current collector substrate.

On the other hand, the carbon nanotube derivative can form a three-dimensional porous scaffold structure on the negative electrode current collector substrate and exhibits high dispersibility in the coating solvent, thereby forming a thin and uniform protective film layer on the negative electrode current collector substrate. As a result, the introduction of the protective film layer can improve the electrochemical stability and interfacial stability between the electrode and the electrolyte. Furthermore, side reactions such as zinc corrosion or dendritic growth can also be reduced.

The carbon nanotube derivative may be a graphene nanoribbon or a graphene oxide nanoribbon, and preferably a graphene oxide nanoribbon.

The graphene oxide nanoribbon has abundant oxygen functional groups such as epoxy groups, hydroxyl groups, and carboxyl groups compared to other carbon nanotube derivatives, thus exhibiting very high dispersibility in a solvent during the preparation of a coating solution, thereby forming a thin and uniform protective film layer and minimizing an increase in resistance due to the introduction of the protective film layer. Furthermore, through strong interaction with zinc atoms, uniform zinc electrodeposition can be induced even under fast charging conditions, thereby improving the interfacial stability between the electrode and the electrolyte.

The protective film layer has high hydrophobicity, which can suppress hydrogen evolution reaction and electrode corrosion occurring at the negative electrode, and can also prevent side reactions such as dendritic growth of zinc.

The protective film layer may have a thickness ranging from 10 to 300 nm, preferably from 20 to 200 nm, more preferably from 30 to 150 nm, and most preferably from 40 to 120 nm. In this regard, if the thickness of the protective film layer is less than 10 nm, the effect of enhancing electrochemical stability and interfacial stability between the electrode and the electrolyte interface may be insignificant, potentially leading to side reactions such as hydrogen evolution reaction, corrosion, and dendritic growth of the electrode. Conversely, if the thickness exceeds 300 nm, the energy density and power density of the zinc-ion battery may decrease due to the high resistance introduced by the protective film layer.

Furthermore, in the present invention, it is preferable that the negative electrode current collector substrate is a copper foil, the carbon nanotube derivative is a graphene oxide nanoribbon, and the protective film layer has a thickness of 40 to 120 nm.

If any of these conditions are not satisfied, the protective film layer may be formed thick and non-uniformly, causing side reactions of the electrode, and zinc may be non-uniformly electrodeposited on the protective film layer, leading to irreversible reactions of the negative electrode, and the Coulombic efficiency may significantly decrease. Moreover, when all the above conditions are satisfied, heterogeneous electrochemical characteristics are also realized, where the optimal interfacial heterogeneity index and zinc deposition overpotential are reduced compared to a homogeneous electrolyte, thus it is particularly preferable to satisfy all the above conditions simultaneously.

Furthermore, the present invention provides a zinc-ion battery comprising: the negative electrode current collector of the present invention; a negative electrode located on the protective film layer of the negative electrode current collector; a positive electrode; and a separator located between the negative electrode and the positive electrode.

Furthermore, the present invention provides a zinc-ion battery further comprising: the negative electrode current collector of the present invention; a positive electrode; and a separator located between the protective film layer of the negative electrode current collector and the positive electrode.

In the various zinc-ion batteries as described above, an electrolyte for a zinc-ion battery may be injected into the separator.

The negative electrode further comprises a negative active material, and the negative active material may be at least one selected from the group consisting of zinc powder, zinc oxide, and calcium zincate, and preferably zinc powder.

The positive electrode may be manufactured by preparing a positive electrode slurry by mixing a positive active material, a binder, and a conductive agent in a process solvent, coating the positive electrode slurry on a positive current collector, and then drying and rolling it.

The positive electrode may be any one selected from manganese or vanadium-based oxides, Prussian blue-based materials, spinel structured oxides, organic materials and Chevrel phase composites, halogen materials, and sulfur-based materials. For example, it may be MnO₂, Mn₂O₃, Mn₃O₄, V₂O₅, VO₂, rGO/VO₂, I₂, etc., but the scope of the present invention is not limited thereto, and positive electrode materials generally applicable to zinc-ion batteries can be applied without limitation.

The positive current collector may be aluminum, stainless steel, nickel, titanium, calcined carbon, or one whose surface is treated with carbon, nickel, titanium, silver, etc., on the surface of aluminum or stainless steel, and is not particularly limited thereto as long as it has conductivity without causing chemical changes in the battery.

The negative electrode may be a current collector capable of electrodepositing zinc, such as copper, titanium, stainless steel, zinc metal foil, zinc metal powder, or an alloy of zinc with another metal. Alternatively, similarly to the positive electrode, it may be manufactured by preparing a negative electrode slurry by mixing a negative electrode active material, a binder, and a conductive agent in a solvent, subsequently coating the negative electrode slurry onto a negative electrode current collector, and then drying and calendering it.

The separator may be at least one selected from the group consisting of glass fiber, silicon oxide-based, polyethylene-based, and polypropylene-based, and preferably glass fiber. In the present invention, the electrolyte for a zinc-ion battery comprises a solvent and a salt, and the solvent may be water, an organic solvent commonly used in zinc-ion batteries, or a mixture thereof.

The salt may comprise a zinc salt, wherein the zinc salt may be a zinc salt comprising at least one anion selected from the group consisting of CF₃SO₃⁻, Cl⁻, Br⁻, I⁻, CH₃COO⁻, NO₃⁻, BF₄⁻, ClO₄⁻, SO₄²⁻, FSI⁻, PF₆⁻, and TFSI⁻.

In the present invention, the electrolyte for a zinc-ion battery may optionally further include a metal salt comprising cations other than zinc, such as a lithium salt, a magnesium salt, a sodium salt, an aluminum salt, and a calcium salt.

The salt may be included in the electrolyte composition at a concentration of 0.1 to 20 m, which can be adjusted depending on the physicochemical properties of the solvent and the solubility of the salt, and may be applied at any concentration within the practically dissolvable limit.

In the present invention, the electrolyte for a zinc-ion battery may also optionally further include additives for improving the electrochemical properties of the electrolyte, such as a film-forming additive (saccharin, trimethylethylammonium trifluoromethanesulfonate (Me₃EtNOTF), KPF₆, etc.), a surface adsorption additive (1-butyl-3-methylimidazolium trifluoromethanesulfonate ([BMIM]OTF), 1-butyl-3-methylimidazolium trifluoromethanesulfonate (BMImOTf), CeCl₃ etc.)

The composition of the electrolyte for a zinc-ion battery of the present invention is not limited to the contents explicitly described in this name-is, and an electrolyte including all solvents, salts, additives, and other components generally applicable to zinc-ion batteries can also be applied without limitation.

Furthermore, the present invention provides a device comprising the zinc-ion battery of the present invention, wherein the device is any one selected from a communication device, a transportation device, and an energy storage device.

Furthermore, the present invention provides a method for manufacturing a negative electrode current collector for a zinc-ion battery, comprising: preparing a carbon nanotube derivative; preparing a coating solution comprising the carbon nanotube derivative and a solvent; applying the coating solution onto a negative electrode current collector substrate; and drying the applied coating solution to form a protective film layer comprising a three-dimensional porous scaffold structure containing the carbon nanotube derivative;

The step of manufacturing the carbon nanotube derivative may further comprise: preparing a dispersion by dispersing carbon nanotubes in an acid solvent; and preparing the carbon nanotube derivative by reacting the dispersion and an oxidant.

The carbon nanotubes may be at least one selected from the group consisting of single-walled carbon nanotubes, double-walled carbon nanotubes, and multi-walled carbon nanotubes, and preferably multi-walled carbon nanotubes.

The acid solvent may be at least one selected from the group consisting of sulfuric acid, fuming sulfuric acid, potassium permanganate, chlorosulfonic acid, fluorosulfonic acid, and trifluoromethanesulfonic acid, and preferably sulfuric acid.

The mixing ratio of the dispersion and the oxidant may be 1:0.1 to 1:100 by weight, preferably 1:1 to 1:10 by weight, and most preferably 1:2 to 1:6 by weight. At this time, if the weight ratio of the oxidant is less than 0.1 by weight, oxidation may proceed insufficiently, hindering the synthesis of the derivative, and conversely, if it exceeds 100 by weight, a vaporization reaction of carbon nanotubes may occur due to complete oxidation.

The oxidant may be at least one selected from the group consisting of permanganates, ferrates, osmates, ruthenates, chlorates, chlorites, nitrates, osmium tetroxide, ruthenium tetroxide, and lead dioxide, and preferably a permanganate.

The permanganate may be potassium permanganate, sodium permanganate, or a mixture thereof, and preferably potassium permanganate.

The solvent may be at least one selected from the group consisting of water, isopropyl alcohol (IPA), ethanol (EtOH), acetone, N-methyl-2-pyrrolidone (NMP), and dimethylformamide (DMF). Preferably, the solvent may be ethanol, acetone, or a mixture thereof, and most preferably acetone.

The concentration of the carbon nanotube derivative in the coating solution may be 0.5 to 100 mg/ml, preferably 1.5 to 10 mg/mL, and most preferably 2 to 5 mg/mL. If the concentration of the carbon nanotube derivative is less than 0.5 mg/mL, insufficient carbon nanotube derivative may be present, limiting efficient protective film coating, and conversely, if it exceeds 100 mg/mL, it may be difficult to coat with a thin thickness due to aggregation between carbon nanotube derivatives.

The coating may be performed by a slot-die coating method or a bar coating method, and preferably by a slot-die coating method. The slot-die coating method can form a more uniform and flat protective film layer on the negative electrode current collector when optimizing the coating solution with a high vapor pressure of 20 kPa@25° C. to 50 kPa@25° C. and a low solvent relative polarity of 0.5 to 0.2.

The drying may be performed at room temperature for 10 to 50 seconds, preferably for 20 to 45 seconds, and most preferably for 25 to 35 seconds. At this time, if any one of the drying temperature and drying time does not satisfy the range, the surface of the protective film layer may not be uniformly flat, or the shape of the three-dimensional scaffold structure may not be properly formed.

In particular, although not explicitly described in the following examples or comparative examples, in the method for manufacturing a negative electrode current collector for a zinc-ion battery according to the present invention, negative electrode current collectors were manufactured under the following conditions, applied to zinc-ion batteries, and subjected to charging and discharging by a conventional method to evaluate ion/electron transfer resistance and fast charging characteristics.

As a result, it was confirmed that when all the conditions below were satisfied, unlike zinc-ion batteries employing the comparative negative electrode current collectors, high electrochemical performance with low charge transfer resistance was exhibited, and fast charging characteristics were very excellent, unlike in other conditions and other numerical ranges.

\textcircled{1} The preparing the carbon nanotube derivative further comprises: preparing a dispersion by dispersing carbon nanotubes in an acid solvent; and preparing the carbon nanotube derivative by reacting the dispersion and an oxidant, \textcircled{2} the carbon nanotubes are multi-walled carbon nanotubes, \textcircled{3} the acid solvent is sulfuric acid, \textcircled{4} the oxidant is potassium permanganate, the mixing ratio of the dispersion and the oxidant is 1:2 to 1:6 by weight, \textcircled{6} the solvent is acetone, \textcircled{7} the concentration of the carbon nanotube derivative in the coating solution is 2 to 5 mg/ml, \textcircled{8} the negative electrode current collector substrate is a copper foil, \textcircled{9} the coating is performed by a slot-die coating method, \textcircled{10}the drying is performed at room temperature for 25 to 35 seconds, \textcircled{11} the carbon nanotube derivative is a graphene oxide nanoribbon, and \textcircled{12} the protective film layer have a thickness of 40 to 120 nm.

However, it was observed that if any one of the conditions above was not satisfied, the ion/electron transfer resistance increased, and the electrochemical performance and fast charging characteristics significantly decreased.

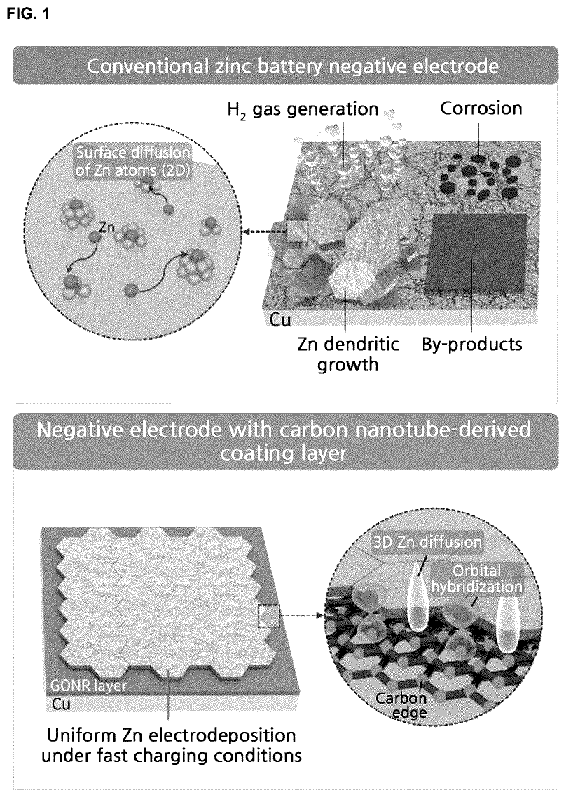

FIG. 1 is a diagram comparing a conventional zinc battery negative electrode and a negative electrode utilizing a negative electrode current collector for a zinc-ion battery according to the present invention. Referring to FIG. 1, the conventional zinc battery negative electrode shows that hydrogen gas is generated on the negative electrode during charging and discharging, the electrode corrodes, and side reactions such as zinc dendritic growth occur.

On the other hand, in the case of a negative electrode incorporating a negative electrode current collector for a zinc-ion battery according to the present invention, it shows that zinc is uniformly electrodeposited as the carbon edges of the protective film layer strongly interact with zinc cations under fast charging conditions.

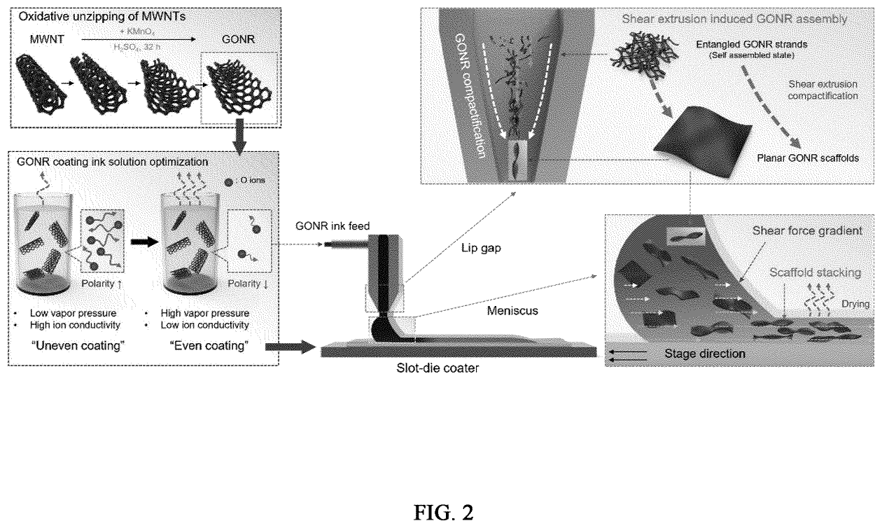

FIG. 2 is a schematic diagram schematically illustrating a method for manufacturing a negative electrode current collector for a zinc-ion battery according to the present invention. Referring to FIG. 2, multi-walled carbon nanotubes are dispersed in an acid solvent and then reacted with an oxidant to form a carbon nanotube derivative in the form of a graphene oxide nanoribbon. The formed carbon nanotube derivative is mixed with a solvent to prepare a coating solution, which is then coated on a negative electrode current collector by a slot-die coating method. After placing the current collector flat on the slot-die coater stage, the speed of the stage is set to 5 mm/s, and the coating solution is injected into the coater through a syringe pump at a speed of 1.1 mL/min to perform coating. The carbon nanotube derivative was extruded using a micro-sized lip gap, thereby promoting self-assembly into planar nanosheets. The nanosheets were deposited on the current collector due to shear force, and thereafter, a thin and uniform protective film layer was shown to be formed through a drying process.

Hereinafter, the present invention will be explained in more detail based on examples, but the present invention is not limited by the following examples.

### EXAMPLES

### Preparation Example 1: Preparation of Electrolyte

An electrolyte was prepared by mixing zinc sulfate heptahydrate (ZnSO₄·7H2O) salt at a 2 molar concentration with water.

### Preparation Example 2: Preparation of CVO Positive Electrode

A positive electrode mixture slurry was prepared by adding CaV₆O₁₆·3H2O (CVO) as a positive active material, carbon black as a conductive agent, and polyvinylidene fluoride (PVdF) as a binder, at 70 wt %, 20 wt %, and 10 wt %, respectively, to N-methyl-2-pyrrolidone (NMP) as a solvent. A positive electrode was prepared by coating the positive electrode mixture slurry on a stainless steel (SUS304) thin film, which is a positive current collector with a thickness of 20 μm, followed by drying, and then rolling (rolling rate 20%) using a roll press.

### Preparation Example 3: Preparation of ZnₓCVO Positive Electrode Containing Zinc Source

After stacking and assembling the CVO positive electrode of Preparation Example 2, a glass fiber separator, and a zinc (Zn) metal negative electrode with a thickness of 250 μm, the electrolyte of Preparation Example 1 was injected into the separator to fabricate a half-cell Zn∥CVO battery. After charging the battery to 1.6 V, the coin cell was disassembled to obtain a ZnₓCVO positive electrode containing a zinc source.

### Example 1: Preparation of GONR-Cu Negative Electrode Current Collector

### (1) Preparation of GONR (Graphene Oxide Nanoribbon) Protective Film

4 g of multi-walled carbon nanotubes (MWNT) were dispersed in 200 mL of sulfuric acid (H₂SO₄), and then potassium permanganate (KMnO₄) as an oxidant was added to the multi-walled carbon nanotubes at a weight ratio of 1:4 to oxidize MWNT for 32 hours to synthesize GONR. Thereafter, 350 mL of tertiary distilled water was added to the mixture, and then 80 mL of hydrogen peroxide (H₂O₂) was added to react, and then the product was obtained. Thereafter, the product was collected and rinsed with tertiary distilled water through vacuum filtration until a neutral pH was reached, thereby obtaining GONR (graphene oxide nanoribbon).

(2) Preparation of Negative Electrode Current Collector Coated with GONR Protective Film

The synthesized GONR was dispersed in acetone at a concentration of 2.5 mg/mL to prepare a coating solution. GONR was coated on a Cu foil having a thickness of 20 μm, which is a negative electrode current collector substrate, using a slot-die coater. After placing the Cu foil flat on the stage, the stage speed was set to 5 mm/s, and the coating was performed while injecting the coating solution into the coater through a syringe pump at a speed of 1.1 mL/min. The Cu film (GONR-Cu) coated with a GONR protective film layer having a thickness of 100 nm was completely dried at room temperature for 30 seconds to obtain a GONR-Cu negative electrode current collector, and stored under vacuum until use.”

### Comparative Example 1: Preparation of Negative Electrode Current Collector

Pristine Cu (p-Cu) without any treatment was prepared as a negative electrode current collector.

### Example 2 and Comparative Example 2: Preparation of Zn@GONR-Cu and Zn@p-Cu Negative Electrodes

Negative Electrode After stacking and assembling the GONR-Cu negative electrode current collector of Example 1 or the p-Cu negative electrode current collector of Comparative Example 1, a glass fiber separator, and a zinc (Zn) metal negative electrode with a thickness of 250 μm, in order, the electrolyte of Preparation Example 1 was injected into the separator to fabricate a half-cell Zn|Cu battery. The fabricated Zn∥Cu battery was discharged by 5 mAh/cm² at a current density of 1 mA/cm², and then the coin cell was disassembled to prepare p-Cu (Zn@p-Cu) and GONR-Cu (Zn@GONR-Cu) negative electrodes with electrodeposited Zn, which were respectively designated as Example 2 and Comparative Example 2 as shown in Table 1 below.

TABLE 1

| Examples | Negative Electrode |
|---|---|
| Comp. Ex. 1 | p-Cu |
| Ex. 1 | GONR-Cu |
| Comp. Ex. 2 | Zn@p-Cu |
| Ex. 2 | Zn@GONR-Cu |

### Example 3 and Comparative Example 3: Preparation of Zn@GONR-Cu∥CVO Cell and Zn@p-Cu∥CVO Cell

Zn@GONR-Cu∥CVO cell (Example 3) and Zn@p-Cu∥CVO cell (Comparative Example 3) were each fabricated by stacking the CVO positive electrode prepared in Preparation Example 2, a glass fiber separator, and the Zn@GONR-Cu negative electrode of Example 2 or the Zn@p-Cu negative electrode of Comparative Example 2.

### Example 4 and Comparative Example 4: Fabrication of GONR-Cu∥ZnₓCVO Anode-free Cell and GONR-Cu∥ZnₓCVO Anode-free Cell

After stacking and assembling the ZnₓCVO positive electrode prepared in Preparation Example 3, a glass fiber separator, and the GONR-Cu negative electrode current collector of Example 1 or the p-Cu negative electrode current collector of Comparative Example 1, GONR-Cu∥ZnₓCVO anode-free cell (Example 4) and p-Cu∥ZnₓCVO anode-free cell (Comparative Example 4) were each manufactured.

### Experimental Example 1: Evaluation of Solvent Dispersibility of GONR Protective Film

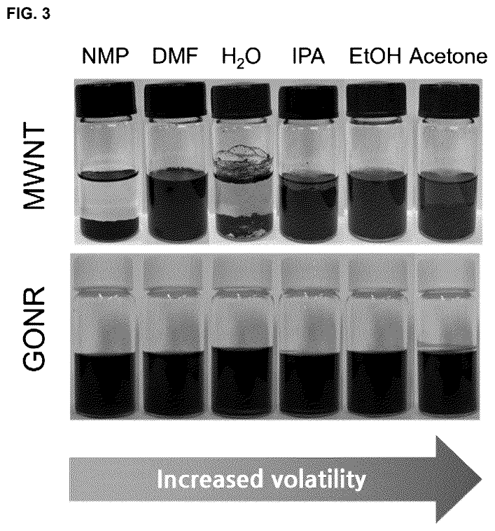

When preparing a coating solution, if the material shows high dispersibility in a solvent, it is easy to fabricate a uniform coating layer, and its dispersibility in various solvents was evaluated. The method for evaluating solvent dispersibility involved dispersing MWNT, which is the starting material of GONR, and the resulting GONR in N-methyl-2-pyrrolidone (NMP), dimethylformamide (DMF), water, isopropyl alcohol (IPA), ethanol (EtOH), and acetone, respectively, at a concentration of 1 mg/mL, and then evaluating dispersibility by visually confirming whether MWNT and GONR were evenly distributed in the solvent, and the results are shown in FIG. 3 and Table 2 below.

FIG. 3 is a photograph showing solvent dispersibility evaluation results for MWNT, which is the starting material of GONR, and the resulting GONR with respect to NMP, DMF, water, IPA, ethanol, and acetone solvents.

TABLE 2

| | NMP | DMF | Water | IPA | Ethanol | Acetone |
|---|---|---|---|---|---|---|
| MWNT | Low | High | Low | High | High | Low |
| GONR | High | High | High | High | High | High |

According to the results of FIG. 3 and Table 2, in the case of GONR, it was confirmed that it showed high dispersibility in various solvents compared to MWNT. Through this, it was understood that a protective film layer of uniform thickness could be formed on the negative electrode current collector substrate. On the other hand, in the case of MWNT, it exhibited low dispersibility with respect to NMP, water, and acetone, confirming that uniform protective film layer coating on the negative electrode current collector substrate was not possible.

### Experimental Example 2: Evaluation of Thickness Uniformity of GONR-Cu Negative Electrode Current Collector

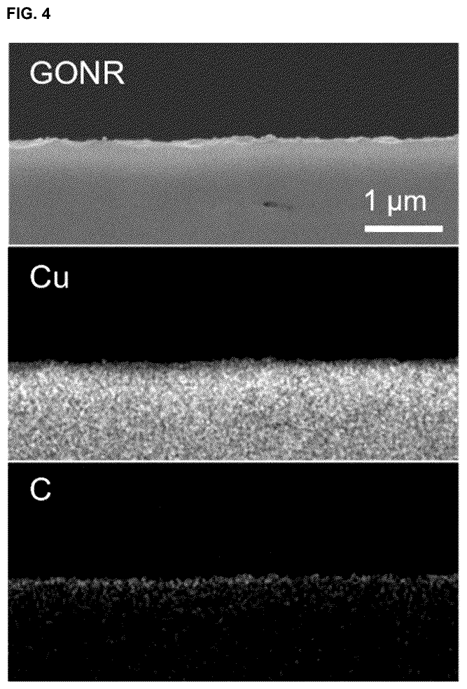

The thickness uniformity of the GONR protective film was evaluated for the GONR-Cu negative electrode current collector manufactured in Example 1. In order for zinc to be uniformly electrodeposited/stripped on the negative electrode surface during battery charging and discharging and to have low resistance, the GONR protective film must be manufactured uniformly and thinly. To confirm the uniformity and thickness of the fabricated GONR protective film, cross-sectional SEM (Scanning Electron Microscope) and EDS (Energy Dispersive Spectrometer) analyses were performed on the GONR-Cu negative electrode current collector of Example 1. The results are shown in FIG. 4.

FIG. 4 shows SEM and EDS analysis results of the GONR-Cu negative electrode current collector manufactured in Example 1 according to the present invention. According to the results of FIG. 4, it was confirmed that the GONR protective film layer was uniformly distributed with a thickness of 200 nm or less on the GONR-Cu negative electrode current collector of Example 1.

### Experimental Example 3: Large-Area Evaluation of GONR-Cu Negative Electrode Current Collector

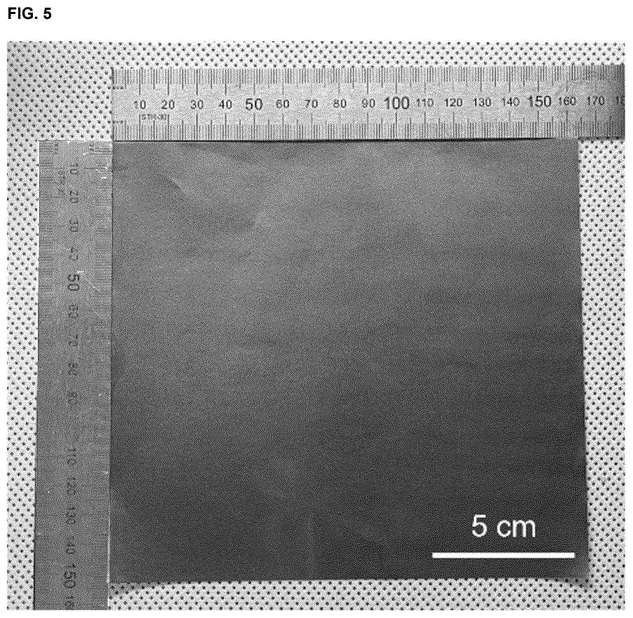

The large-area application of the negative electrode current collector was evaluated for the GONR-Cu negative electrode current collector manufactured in Example 1, utilizing a slot die coater. The results are shown in FIG. 5.

FIG. 5 is a photograph of the GONR-Cu negative electrode current collector manufactured in Example 1, produced using a slot die coater. Referring to FIG. 5, it was confirmed that the negative electrode current collector of Example 1 can secure an area of 15×15 cm². Through this, when the GONR-Cu negative electrode current collector is applied to a negative electrode by a simple process, large-area application is possible, and commercial application of zinc-ion batteries using such large-area negative electrodes.

### Experimental Example 4: Evaluation of Charge/Discharge Efficiency of Zn∥GONR-Cu Cell

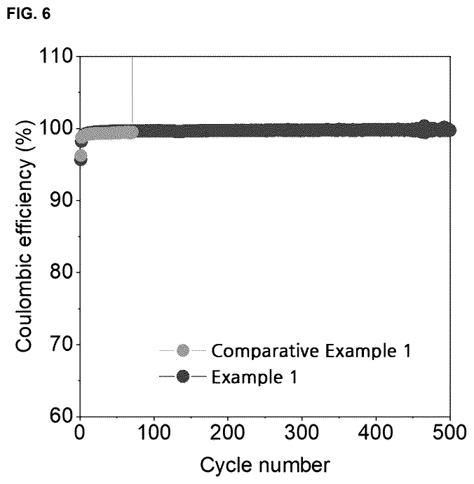

The GONR-Cu negative electrode current collector of Example 1 and the p-Cu negative electrode current collector of Comparative Example 1 were each applied to a Zn|Cu cell, discharged at a current density of 5 mA/cm² and an areal capacity of 2 mAh/cm², and then charged to 0.4 V at the same current density as one cycle, and Coulombic efficiency was evaluated by repeating cycles. The Coulombic efficiency for each cycle was calculated by multiplying the ratio of stripped zinc to electrodeposited zinc by 100. After calculating the Coulombic efficiency for each cycle for 500 cycles, the average Coulombic efficiency was calculated by dividing the sum of the Coulombic efficiency values for all cycles by the number of cycles. The results are shown in FIG. 6 and Table 3 below.

FIG. 6 is a Coulombic efficiency graph according to the number of cycles for the Zn∥GONR-Cu cell and Zn|p-Cu cell, respectively, manufactured using the GONR-Cu negative electrode current collector of Example 1 and the p-Cu negative electrode current collector of Comparative Example 1 according to the present invention.

Table 3 below shows the number of cycles at which an internal short circuit occurred in the Zn|Cu cell and the average Coulombic efficiency values during 500 cycles. Cases where Coulombic efficiency could not be measured due to an internal short circuit caused by zinc dendritic growth are indicated as “Not measurable”.

TABLE 3

| | Internal Short Circuit | Average Coulombic |
|---|---|---|
| | Occurrence Cycle | Efficiency |
| Comp. Ex. 1 (Zn∥p-Cu) | 72 cycles | Not measurable |
| Ex. 1 (Zn∥GONR-Cu) | No internal short | 99.7% |
| | circuit occurred | |

According to the results of FIG. 6 and Table 3, it was confirmed that in the Zn|GONR-Cu cell applying the GONR-Cu negative electrode current collector of Example 1, no internal short circuit occurred during 500 cycles, and the average Coulombic efficiency was very high at 99.7%.

On the other hand, in the Zn∥p-Cu cell applying the p-Cu negative electrode current collector of Comparative Example 1, an internal short circuit occurred at 72 cycles, making it impossible to expect further charge/discharge efficiency, and accordingly, the average Coulombic efficiency could not be measured. Through this, it was understood that when using the p-Cu negative electrode current collector of Comparative Example 1, side reactions such as hydrogen evolution reaction, zinc corrosion, and dendritic growth occurred when the zinc negative electrode and the electrolyte met, and the reversibility of the zinc negative electrode decreased, leading to a decrease in the Coulombic efficiency (%) of the battery.

### Experimental Example 5: Evaluation of Charge/Discharge Efficiency of Zn@GONR-Cu∥CVO Cell

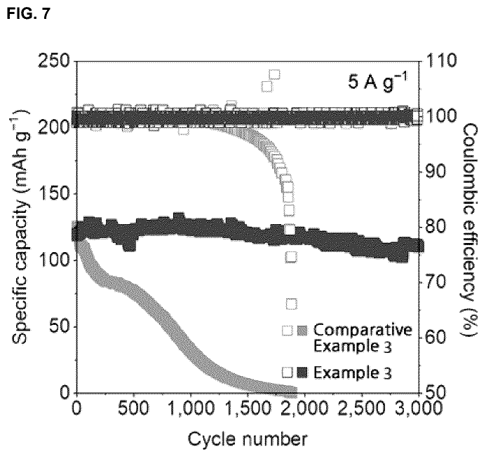

The Zn@GONR-Cu∥CVO cell of Example 3 and the Zn@p-Cu∥CVO cell of Comparative Example 3 were used to perform charging and discharging at a current density of 5 A/g within a voltage range of 0.2 V to 1.6 V. Thereafter, the capacity retention rate after 3000 cycles for each Zn@Cu∥CVO cell was evaluated. The capacity retention rate was calculated by dividing the discharge capacity after 3000 cycles by the discharge capacity after the first cycle and multiplying by 100. The results are shown in FIG. 7.

FIG. 7 is a graph illustrating the specific capacity and Coulombic efficiency over 3000 cycles for the Zn@GONR-Cu|CVO cell of Example 3 and the Zn@p-Cu∥CVO cell of Comparative Example 3.

Table 4 below shows the capacity retention rates after 3000 cycles for the Zn@GONR-Cu∥CVO cell of Example 3 and the Zn@p-Cu∥CVO cell of Comparative Example 3.

TABLE 4

| Category | Retention Rate |
|---|---|
| Comp. Ex. 3 (Zn@p-Cu∥CVO) | 0% |
| Ex. 3 (Zn@GONR-Cu∥CVO) | 91.8% |

According to the results of FIG. 7 and Table 4, in the Zn@GONR-Cu∥CVO cell of Example 3, both specific capacity and Coulombic efficiency were excellent during 3000 cycles and remained almost constant, and in particular, the capacity retention rate showed a very high value of 91.8%.

On the other hand, in the Zn@p-Cu∥CVO cell of Comparative Example 3, during the charge/discharge process, zinc grew into dendritic crystals and detached, the electrolyte decomposed on the zinc negative electrode surface to generate hydrogen, or zinc negative electrode corrosion or passivation film formation occurred, which sharply decreased the battery capacity as the number of cycles increased, and the capacity retention rate was not measurable.

### Experimental Example 6: Evaluation of Charge/Discharge Efficiency of GONR-Cu∥ZnₓCVO Anode-Free Cell

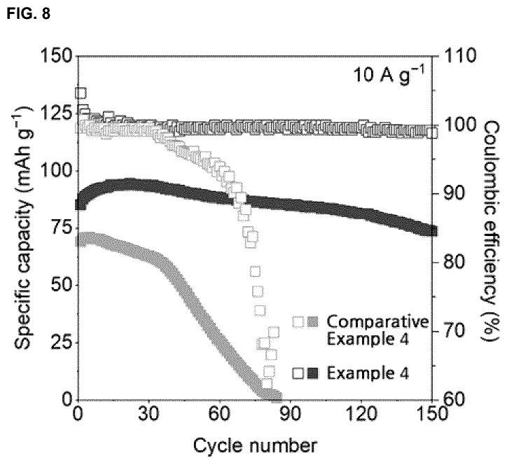

The GONR-Cu|ZnₓCVO anode-free cell of Example 4 and the p-Cu∥ZnₓCVO anode-free cell of Comparative Example 4 were used to perform charging and discharging at a current density of 10 A/g within a voltage range of 0.2 V to 1.6 V. Thereafter, the Coulombic efficiency for each cycle was calculated by multiplying the ratio of discharge capacity to charge capacity by 100. After calculating the Coulombic efficiency for each cycle for 150 cycles, the average Coulombic efficiency was calculated by dividing the sum of the Coulombic efficiency values for all cycles by the number of cycles. Thereafter, the capacity retention rate after 150 cycles for each Cu∥ZnₓCVO cell was evaluated. The capacity retention rate was calculated by dividing the discharge capacity after 150 cycles by the discharge capacity after the first cycle and multiplying by 100. The results are shown in FIG. 8 and Table 5.

FIG. 8 is a graph showing the specific capacity and Coulombic efficiency over 150 cycles for the GONR-Cu∥ZnₓCVO anode-free cell of Example 4 and the p-Cu∥ZnₓCVO anode-free cell of Comparative Example 4 according to the present invention.

Table 5 below shows the average Coulombic efficiency and capacity retention rate after 150 cycles for the GONR-Cu∥ZnₓCVO anode-free cell of Example 4 and the p-Cu∥ZnₓCVO anode-free cell of Comparative Example 4.

TABLE 5

| | Average Coulombic | Retention |
|---|---|---|
| Category | Efficiency Capacity | Rate |
| Comp. Ex. 4 | Not measurable | 0% |
| (p-Cu∥ZnₓCVO Anode-free Cell) | | |
| Ex. 4 | 99.7% | 86.3% |
| (GONR-Cu∥ZnₓCVO Anode-free Cell) | | |

According to the results of FIG. 8 and Table 5, the GONR-Cu∥ZnₓCVO anode-free cell of Example 4 demonstrated excellent specific capacity and Coulombic efficiency over 150 cycles, and remained almost constant. Furthermore, the average Coulombic efficiency was 99.7% and the capacity retention rate was 86.3%, each indicating excellent values. In addition, because only a negative electrode current collector is used instead of a thick metal negative electrode, the energy density of the cell can be maximized.

On the other hand, in the p-Cu∥ZnₓCVO anode-free cell of Comparative Example 4, the chemical/electrochemical stability between the negative electrode and the aqueous electrolyte was very low, and accordingly, the specific capacity and Coulombic efficiency sharply decreased after 60 cycles. As a result, the average Coulombic efficiency and capacity retention rate could not be measured, and consequently, it was confirmed that securing long-term life was difficult.

What is claimed is:

1. A negative electrode current collector for a zinc-ion battery, comprising:
a negative electrode current collector substrate; and
a protective film layer located on the negative electrode current collector substrate and comprising a three-dimensional porous scaffold structure containing a carbon nanotube derivative.

2. The negative electrode current collector for a zinc-ion battery according to claim 1, wherein the negative electrode current collector substrate is at least one selected from the group consisting of a copper foil, a graphite foil, a carbon fiber, a zinc foil, titanium, and stainless steel.

3. The negative electrode current collector for a zinc-ion battery according to claim 1, wherein the carbon nanotube derivative is a graphene nanoribbon or a graphene oxide nanoribbon.

4. The negative electrode current collector for a zinc-ion battery according to claim 1, wherein the protective film layer has a thickness of 10 to 300 nm.

5. The negative electrode current collector for a zinc-ion battery according to claim 1, wherein the negative electrode current collector substrate is a copper foil; the carbon nanotube derivative is a graphene oxide nanoribbon; and the protective film layer has a thickness of 40 to 120 nm.

6. A zinc-ion battery comprising:
the negative electrode current collector of claim 1;
a negative electrode located on the protective film layer;
a positive electrode; and
a separator located between the negative electrode and the positive electrode.

7. A zinc-ion battery further comprising:
the negative electrode current collector of claim 1;
a positive electrode; and
a separator located between the protective film layer and the positive electrode.

8. The zinc-ion battery according to claim 6, wherein the positive electrode is any one material selected from manganese or vanadium-based oxides, Prussian blue-based materials, spinel structured oxides, organic materials and Chevrel phase composites, halogen materials, and sulfur-based materials

9. The zinc ion battery according to claim 6, further comprising a zinc ion battery electrolyte injected into the separator,
wherein the zinc ion battery electrolyte comprises a solvent and a salt;
the solvent is water or an organic solvent, or a mixture thereof;
the salt comprises a zinc salt; and
the zinc salt comprises at least one anions selected from the group consisting of CF₃SO₃⁻, Cl⁻, Br⁻, I⁻, CH₃COO⁻, NO₃⁻, BF₄⁻, ClO₄⁻, SO₄²⁻, FSI⁻, PF₆⁻, and TFSI⁻.

10. The zinc-ion battery according to claim 9,
wherein the electrolyte for a zinc-ion battery further comprises at least one selected from the group consisting of a lithium salt, a magnesium salt, a sodium salt, an aluminum salt, and a calcium salt; and
the aqueous-organic composite electrolyte for a zinc-ion battery further comprises at least one additives selected from a film-forming additive, a surface adsorption additive, and an organic solvent additive.

11. The zinc-ion battery according to claim 6, wherein the negative electrode further comprises a negative active material.

12. The zinc-ion battery according to claim 11, wherein the negative active material is at least one selected from the group consisting of zinc powder, zinc oxide, and calcium zincate.

13. A device comprising the zinc-ion battery of claim 6, wherein the device is any one selected from a communication device, a transportation device, and an energy storage device.
